(19) United States
(12) Patent Application Publication
(10) Pub. No.: US 2020/0200573 A1
(43) Pub. Date: Jun. 25, 2020

(54) CALIBRATION METHOD OF MULTIPLE INERTIAL MEASUREMENT UNITS ON MULTI-LINKAGE SYSTEM

(71) Applicant: National Tsing Hua University, Hsinchu City (TW)

(72) Inventors: Hsien-Ting Chang, Hsinchu City (TW); Jen-Yuan Chang, Hsinchu City (TW)

(21) Appl. No.: 16/278,205

(22) Filed: Feb. 18, 2019

(30) Foreign Application Priority Data
Dec. 22, 2018 (TW) 107146674

(51) Int. Cl. G01D 18/00; G01D 21/02; G06F 3/01

(52) U.S. Cl. CPC G01D 18/00; G06F 3/014; G01D 21/02

(57) ABSTRACT

The invention discloses a calibration method for multiple IMU on multi-linkage system, the system comprising: a plurality of IMUs, wherein the plurality of IMUs is respectively arranged in a plurality of links of the multi-linkage system. Each of the IMUs further includes an accelerometer, a magnetometer, a gyroscope, and a calculation and compensation unit (CCU); the calibration method includes: CCU selecting the communication channel and initializing parameters; CCU selecting the communication channel and performing object vector information calculation, rotation compensation, and installation error compensation respectively; calculates the angle between each IMU and the position endpoints of each IMU; and outputting the compensated object vector information, the angle, and the endpoint positions.

### TECHNICAL FIELD

The technical field generally relates to a calibration method of multiple inertial measurement units on multi-linkage system.

### BACKGROUND

With the increasing demand for human-computer interaction in recent years, such as, VR, AR, film industry, sports science measurement, and medical industry, the development of multi-linkage system has gradually attracted the attention of the academic community and the industry because the multi-linkage system is applicable to the human body posture measurement as well as robotic arm applications. The so-called multi-linkage system generally refers to a multi-rigid body composed of a plurality of rigid links through a plurality of connections, wherein each link can move in a non-detached manner at the connection with other links, and each link maintains the property of rigidity, i.e., a link is a rigid body.

Traditionally, human body pose measurement devices uses mostly visually-based recognition, but the application is limited by the measurement site and often encounters light-shielding problems. For this specific reason, how to design wearable multi-linkage measurement system able to avoid the light-shielding and ambient light interference has also become an important issue in practical industrial applications.

Taiwan Patent No. 1612276 disclosed an object pose measurement system based on MEMS IMU and method thereof, wherein three types of sensors in the inertial measurement unit (IMU), such as, an accelerometer, a magnetometer, and a gyroscope, measure the gravity, geomagnetic direction and the rotational speed of the object; then using the above three kinds of measurements are used in a mathematical model to determine the pose of the object. When the IMU is fixed to a rigid object, the patented invention is able to measure the pose of the object. In other words, if a plurality of inertial measurement units in Taiwan Patent No. 1612276 are respectively integrated into a multi-linkage device or object, the plurality of IMUs can form a measurement tool for a multi-linkage system. That is, by using each IMU to sense pose of each connected link, with the length of each connected link, the position of each endpoint in the multi-linkage system can be known and the trajectory can be recorded. Furthermore, the angles exhibited by the respective links can also be measured by the respective IMUs and can be recorded for various applications.

However, if the plurality of IMUs is directly integrated onto a multi-linkage device or object, especially an object of an irregular shape, measurement errors may easily occur. The main reason is that, under ideal conditions, a specific axis of the IMU is assumed to perfectly fit an object, and the object pose can be presented by calculating the specific axis of the IMU in the reference coordinate system. However, in the actual situation, due to the lack of a mounting surface, the IMU may have a mounting error. Furthermore, since the IMU can only measure the object pose, to accurately measure the exact position of each endpoint in the multi-link system, it is necessary to first measure the length of each link and the relative position between each other. FIG. 1 is a schematic view showing the integration of a plurality of IMUs into a measuring glove; and FIG. 2 is a schematic view of the knuckles corresponding to the uncalibrated IMU. As shown in FIG. 1 and FIG. 2, since the lengths of the knuckles of the fingers are different, the relative positions between the IMUs are not completely consistent; if not calibrated, subsequent measurement errors are inevitable.

### SUMMARY

An embodiment of the present invention provides a calibration method of multiple IMUs on multi-linkage system, applicable to integrating a multi-linkage system integrated with multiple IMUs, the multi-linkage system integrated with multiple IMUs comprising: a plurality of IMUs, each IMU disposed respectively on a different connecting link of the multi-linkage system; wherein each IMU further comprising an accelerometer, a magnetometer, a gyroscope, and a calculation and compensation unit; the calibration method further comprising: selecting a communication channel according to a number of the calculation and compensation unit and a distribution design information, and initializing setting parameters of each calculation and compensation unit; selecting a communication channel according to a number of the calculation and compensation unit and a distribution design information, and each calculation and compensation unit respectively calculating an object vector information based on measurement information respectively from the accelerometer, the magnetometer, and the gyroscope, performing rotation compensation, performing mounting error compensation to obtain a compensated object vector information; calculating an angle between adjacent connected IMUs and positions of endpoints of the IMUs; outputting the compensated object vector information, angles between adjacent connected IMUs, positions of endpoints of IMUs.

In a preferred embodiment, the step of initializing setting parameters of each calculation and compensation unit further comprises: setting a relative position of a link to be calibrated according to a link connection relationship information; setting a length of the link to be calibrated according to a link length information; setting a measurement rate, a measurement range, and resolution of the calculation and compensation unit.

In a preferred embodiment, in the step of the calculation and compensation unit performing mounting error compensation according to a mounting error information: the mounting error information is obtained through a mounting error measurement process, and the mounting error measurement process comprises: mounting the IMU on a link to be calibrated; fixing the link to be calibrated on a rotating platform, the rotating platform has a rotating axis coincided with a specific direction of the link to be calibrated, and recording an initial pose of the link to be calibrated; the link to be calibrated being rotated by a specific angle in accordance with the rotation axis of the rotating platform; measuring a pose of the link to be calibrated after the rotation; according to the initial pose, the posture after the rotation, and the rotation angle, calculating the mounting error information.

In a preferred embodiment, when calculating the angle between two adjacent links, the method comprises: first calculating the difference of the pose information of the two adjacent links, and then converting to a roll angle (φ), a pitch angle (θ) and a yaw angle (ψ); wherein the pose information is expressed in a quaternion.

In a preferred embodiment, the calculation of the relative positions of the endpoints of the respective links is according to the relationship between an orientation vector of the link and a specific vector of the IMU; the IMU calculates the pose information of the link, and calculates the orientation vector of the link with the posture information; finally, the endpoints of each connecting link is calculated by adding a relative origin of each previous connecting link as vectors.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of the integration of a plurality of inertial measurement units into a measuring glove;

FIG. 2 shows a schematic view of the knuckle corresponding to the uncalibrated inertial measurement unit;

FIG. 3 shows a schematic view of a flowchart of calibration method of multiple IMU on multi-linkage system according to the present invention;

FIG. 4 shows a schematic view of the numbering of the IMU in the measuring glove in FIG. 1;

FIG. 5 shows a flowchart of the steps of initializing the setting parameters of each calculation and compensation unit in the calibration method of multiple IMU on multi-linkage system according to the present invention;

FIG. 6 shows a flowchart of the mounting error measurement process used in the multiple IMU on multi-linkage system according to the present invention;

FIG. 7 shows a schematic view of calculating the angle between the links of the present invention;

FIG. 8 shows a schematic view of the calculation of the endpoints of the respective links by performing vector addition on the relative origin of the respective links;

FIG. 9 shows a schematic view of the knuckle corresponding to the calibrated IMU in FIG. 2.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present invention discloses a calibration method of multiple IMUs on multi-linkage system; the multiple IMUs on multi-linkage system can be implemented by mounting multiple IMUs respectively on different linkage portions of a rigid body having multiple links.

The calibration method of multiple IMUs on multi-linkage system is applicable to a multiple IMUs integrated into a multi-linkage system, the system comprises: a plurality of IMUs, each IMU disposed respectively on a different connecting link of the multi-linkage system; wherein each IMU further comprises an accelerometer, a magnetometer, a gyroscope, and a calculation and compensation unit; the calculation and compensation unit respectively calculates an object vector information based on measurement information respectively from the accelerometer, the magnetometer, and the gyroscope, performs rotation compensation, performs mounting error compensation to obtain a compensated object vector information for outputting.

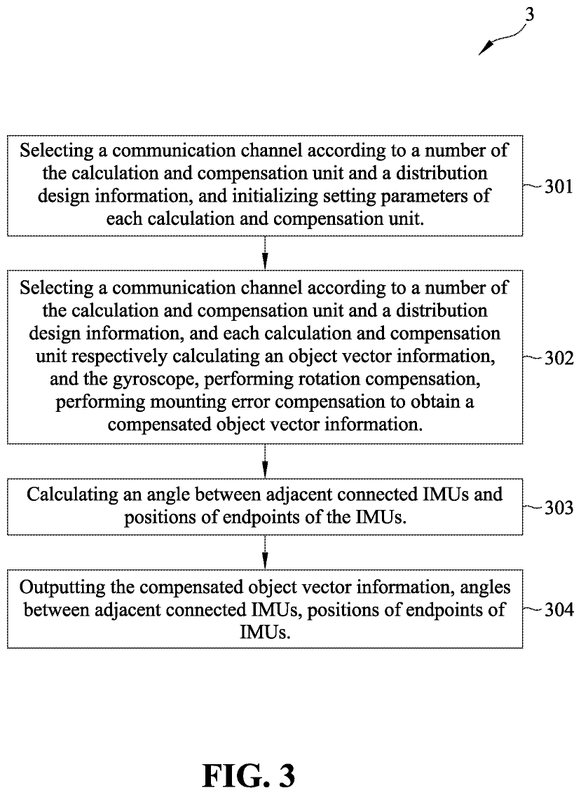

The calibration method of multiple IMUs on multi-linkage system of the present invention will calibrate the mounting error of the plurality of IMUs to improve the accuracy of the measurement. Referring to FIG. 3, FIG. 3 is a flowchart of the calibration method of multiple IMUs on multi-linkage system according to the present invention. As shown in FIG. 3, the calibration method of multiple IMUs on multi-linkage system of the present invention further comprises the following steps:

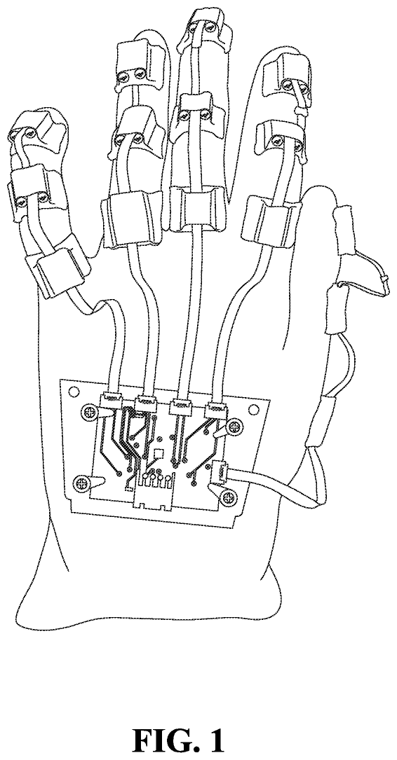

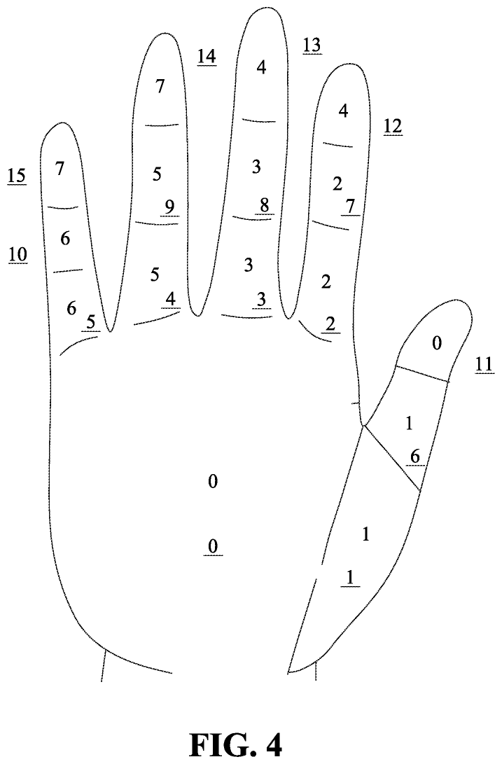

Step 301: selecting a communication channel according to a number of the calculation and compensation unit and a distribution design information, and initializing setting parameters of each calculation and compensation unit. Since the information between the calculation and compensation units must be integrated for calibration, each calculation and compensation unit must select the communication channel based on a number assigned to the calculation and compensation unit and distribution design information of each calculation and compensation unit, including, for example, a multiplexer or other communication hardware, and so on. For example, FIG. 4 is a schematic view showing the numbering of the IMU in the measuring glove in FIG. 1. The underscored numbers 0-15 represent the number assigned to the IMU, and the non-underscored numbers represent the selected communication channel. Next, the parameters of each calculation and compensation unit are initialized.

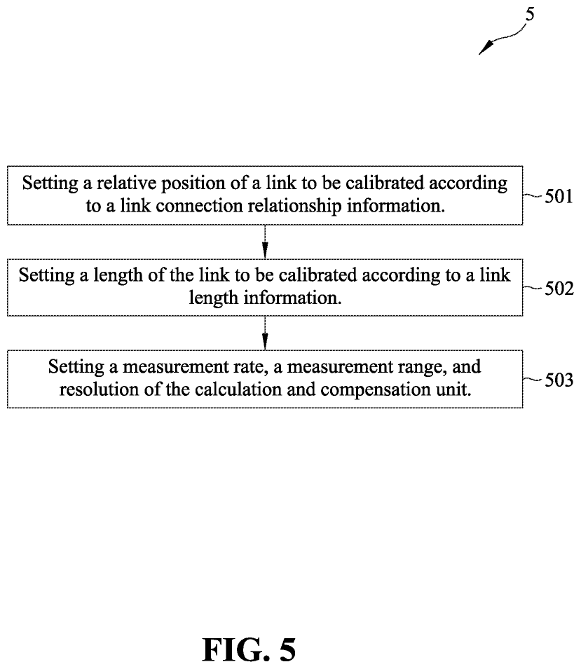

FIG. 5 shows a flowchart of the steps of initializing the setting parameters of each calculation and compensation unit in the calibration method of multiple IMU on multi-linkage system according to the present invention. As shown in FIG. 5, the step of initializing the setting parameters of each calculation and compensation unit further comprises: step 501: setting a relative position of a link to be calibrated according to a link connection relationship information; step 502: setting a length of the link to be calibrated according to a link length information; step 503: setting a measurement rate, a measurement range, and resolution of the calculation and compensation unit. It should be noted that the link connection relationship information, the link length information, and so on are pre-prepared information, and the present invention is not limited to any particular format of the information. After the initialization setting parameters are completed, the calibration method of the present invention proceeds to step 302 to perform object vector information calculation and related compensation operations.

Step 302: selecting a communication channel according to a number of the calculation and compensation unit and a distribution design information, and each calculation and compensation unit respectively calculating an object vector information, performing rotation compensation, performing mounting error compensation to obtain a compensated object vector information. Wherein, The step of selecting the communication channel according to the number of the calculation and compensation unit and distribution design information is the same as the foregoing; and the method of calculating the object vector information and performing rotation compensation are the same as the method for measuring the pose of the object based on IMU disclosed in Taiwan Patent No. 1612276. In other words, the calculation and compensation unit of the present invention performs the rotation compensation based on the measurement method based on IMU in the disclosed foregoing prior art, and then performs the mounting error compensation.

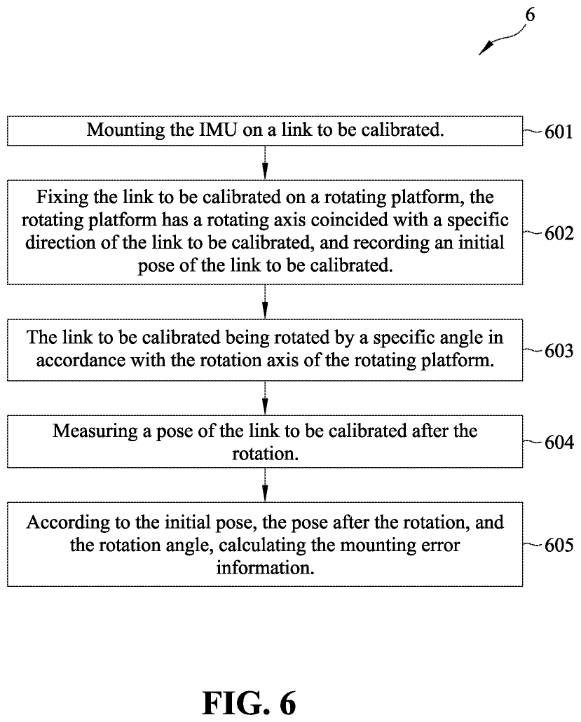

In a preferred embodiment, the calculation and compensation units perform mounting error compensation based on a mounting error information, and the mounting error information can be obtained through a mounting error measurement process. FIG. 6 shows a flowchart of the mounting error measurement process used in the multiple IMU on multi-linkage system according to the present invention. As shown in FIG. 6, the mounting error measurement process comprises: step 601: mounting the IMU on a link to be calibrated; step 602: fixing the link to be calibrated on a rotating platform, the rotating platform has a rotating axis coincided with a specific direction of the link to be calibrated, and recording an initial pose of the link to be calibrated; step 603: the link to be calibrated being rotated by a specific angle in accordance with the rotation axis of the rotating platform; step 604: measuring a pose of the link to be calibrated after the rotation; step 605: according to the initial pose, the posture after the rotation, and the rotation angle, calculating the mounting error information.

Step 303: calculating an angle between adjacent connected IMUs and positions of endpoints of the IMUs; and Step 304: outputting the compensated object vector information, angles between adjacent connected IMUs, positions of endpoints of IMUs.

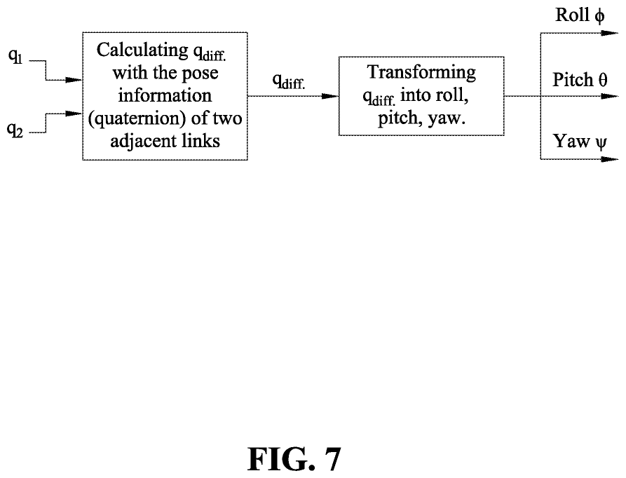

In a preferred embodiment, the angle between the connecting links to which the IMUs are mounted and the endpoint positions of the connecting links are respectively described as follows: since the object pose information calculated and outputted by the algorithm of the invention is in the quaternion format. Therefore, when calculating the angle between the links, the method comprises: first calculating the difference of the pose information of the two adjacent links, and then converting to a roll angle (φ), a pitch angle (θ) and a yaw angle (ψ). Referring to FIG. 7, FIG. 7 is a schematic view showing the angle between the links.

First, The two quaternions representing the two adjacent link pose information q₁, q₂ are divided to obtain q_{diff}=q₁/q₂; wherein q_{diff} represents the difference in rotation between two adjacent objects (based on q₂).

Also, q₁ and q₂ are expressed as follows:

q₁=(w₁+x₁i+y₁j+z₁k)

q₂=(w₂+x₂i+y₂j+z₂k)

Because the quaternion (q₁, q₂) representing the pose information is a unit quaternion; i.e., (w²+x²+y²+z²=1); q_{diff} can be expressed as q_{diff.}=q₁*q₂*, wherein q₂*=(w₂−x₂i−y₂j−z₂k).

According to the quaternion calculation rules, the calculation of q_{diff} is as follows:

q_{diff.}=q₁*q₂*=[(w₁*w₂+x₁*x₂+y₁*y₂+z₁*z₂)+(−w₁*x₂+x₁*w₂−y₁*z₂+z₁*y₂)i+(−w₁*y₂+x₁*z₂+y₁*w₂−z₁*x₂)j+(−w₁*z₂−x₁*y₂+y₁*x₂+z₁*w₂)k]

Then, the calculated result of the q_{diff} is transformed to the three rotation angles: a roll angle (φ), a pitch angle (θ) and a yaw angle (ψ):

q_{diff.}=(q_{d0}+q_{d1}i+q_{d2}j+q_{d2}k)

Wherein, the results of the four parameters are:

q_{d0}=(w₁*w₂+x₁*x₂+y₁*y₂+z₁*z₂)

q_{d1}=(−w₁*x₂+x₁*w₂−y₁*z₂+z₁*y₂)

q_{d2}=(−w₁*y₂+x₁*z₂+y₁*w₂−z₁*x₂)

q_{d3}=(−w₁*z₂−x₁*y₂+y₁*x₂+z₁*w₂)

And the results of the angle transformation are:

ϕ=tan⁻¹[2(q_{d0}q_{d3}+q_{d1}q_{d2}),1−2(q_{d2}²+q_{d2}²)]

θ=sin⁻¹[2(q_{d0}q_{d2}−q_{d1}q_{d3})]

φ=tan⁻¹[2(q_{d0}q_{d1}+q_{d2}q_{d3}),1−2(q_{d1}²+q_{d2}²)]

Up to this point, a link can be calibrated by using another link as a reference basis.

Furthermore, when calculating the relative position of the endpoint of the connecting link, it is necessary to first know the relationship between an orientation vector of the connecting link and a specific vector of the IMU (here, the Y-axis of the IMU is attached to the length of the link). The link pose information q (quaternion) is calculated by the IMU, and the orientation vector of the link is calculated with the pose information, for example, the specific axis \vec{ν} (using Y-axis as example), \vec{ν}=[0 1 0], after rotation, the specific axis becomes \vec{ν}′. Then, define as a computation to expand a spatial vector into four elements, such as,

t(\vec{ν})=(0,\vec{ν})=[0 0 1 0]; t(\vec{ν}′)=q*t(\vec{ν})*q,

Wherein the quaternion multiplication is as the foregoing.

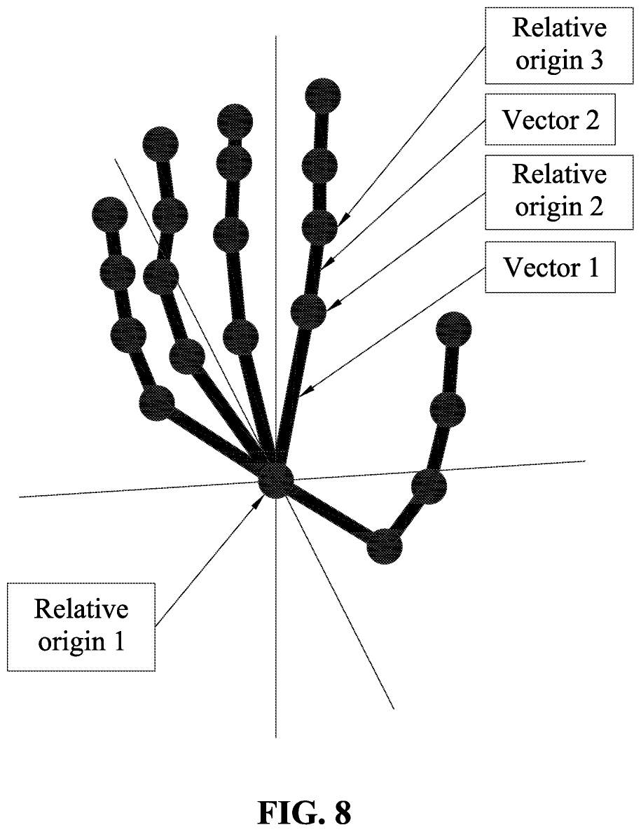

Finally, as shown in FIG. 8, vectors are added from the relative origin of each link to calculate the endpoints of each link, for example:

End point 1 position=relative origin 1+vector 1

Endpoint 2 position=relative origin 2+vector 2

In other words, in FIG. 8, relative origin 1 is the relative origin of the vector 1 endpoint 1 is the relative origin of the vector 2, that is, the relative origin 2; likewise, the endpoint 2 is the relative origin of vector 3, that is, relative origin 3.

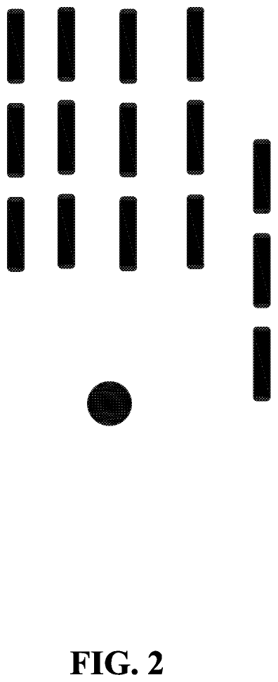

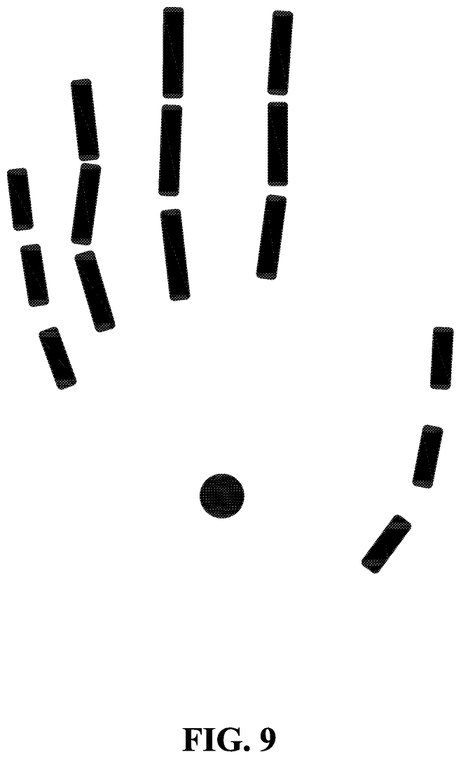

FIG. 9 shows a schematic view of the knuckle corresponding to the calibrated IMU in FIG. 2. As shown in FIG. 9, after calibration, the knuckle length of each IMU on the glove to be calibrated and endpoint position can better reflect the measurement information of each IMU on the glove.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A calibration method of multiple inertial measurement units (IMUs) on multi-linkage system, applicable to integrating a multi-linkage system integrated with multiple IMUs, the multi-linkage system integrated with multiple IMUs comprising: a plurality of IMUs, each IMU disposed respectively on a different connecting link of the multi-linkage system; wherein each IMU further comprising an accelerometer, a magnetometer, a gyroscope, and a calculation and compensation unit; the calibration method further comprising:
selecting a communication channel according to a number of the calculation and compensation unit and a distribution design information, and initializing setting parameters of each calculation and compensation unit;
selecting a communication channel according to a number of the calculation and compensation unit and a distribution design information, and each calculation and compensation unit respectively calculating an object vector information based on measurement information respectively from the accelerometer, the magnetometer, and the gyroscope, performing rotation compensation, performing mounting error compensation to obtain a compensated object vector information;
calculating an angle between adjacent connected IMUs and positions of endpoints of the IMUs;
outputting the compensated object vector information, angles between adjacent connected IMUs, positions of endpoints of IMUs.

2. The calibration method of multiple IMUs on multi-linkage system as claimed in claim 1, wherein the step of initializing setting parameters of each calculation and compensation unit further comprises:
setting a relative position of a link to be calibrated according to a link connection relationship information;
setting a length of the link to be calibrated according to a link length information;
setting a measurement rate, a measurement range, and resolution of the calculation and compensation unit.

3. The calibration method of multiple IMUs on multi-linkage system as claimed in claim 1, wherein in the step of the calculation and compensation unit performing mounting error compensation according to a mounting error information: the mounting error information is obtained through a mounting error measurement process, and the mounting error measurement process comprises:
mounting the IMU on a link to be calibrated;
fixing the link to be calibrated on a rotating platform, the rotating platform has a rotating axis coincided with a specific direction of the link to be calibrated, and recording an initial pose of the link to be calibrated;
the link to be calibrated being rotated by a specific angle in accordance with the rotation axis of the rotating platform;
measuring a pose of the link to be calibrated after the rotation;
according to the initial pose, the posture after the rotation, and the rotation angle, calculating the mounting error information.

4. The calibration method of multiple IMUs on multi-linkage system as claimed in claim 1, wherein when calculating the angle between two adjacent links, the method comprises: first calculating the difference of the pose information of the two adjacent links, and then converting to a roll angle (φ), a pitch angle (θ) and a yaw angle (ψ).

5. The calibration method of multiple IMUs on multi-linkage system as claimed in claim 4, wherein the pose information is expressed in a quaternion.

6. The calibration method of multiple IMUs on multi-linkage system as claimed in claim 1, wherein the calculation of the relative positions of the endpoints of the respective links is according to the relationship between an orientation vector of the link and a specific vector of the IMU; the IMU calculates the pose information of the link, and calculates the orientation vector of the link with the posture information; finally, the endpoints of each connecting link is calculated by adding a relative origin of each previous connecting link as vectors.
